(19) United States
(12) Patent Application Publication
(10) Pub. No.: US 2023/0266234 A1
(43) Pub. Date: Aug. 24, 2023

(54) Spectrometer Device and Method for Measuring Optical Radiation

(71) Applicant: TRINAMIX GMBH, Ludwigshafen am Rhein (DE)

(72) Inventors: Celal Mohan OEGUEN, Ludwigshafen (DE); Stefan HOOS, Ludwigshafen (DE); Robert GUST, Ludwigshafen (DE); Sebastian VALOUCH, Ludwigshafen (DE); Patrick SCHINDLER, Ludwigshafen am Rhein (DE)

(21) Appl. No.: 18/006,438

(22) PCT Filed: Jul. 23, 2021
(86) PCT No.: PCT/EP2021/070644

§ 371 Date: Jan. 23, 2023

(30) Foreign Application Priority Data
Jul. 24, 2020 (EP) 20187757.8

(51) Int. Cl. G01N 21/31

(52) U.S. Cl. CPC G01N 21/31

(57) ABSTRACT

Disclosed herein are a spectrometer device, a method for measuring optical radiation, and a spectrometer system including the spectrometer device. The spectrometer device includes
at least one radiation emitting element,
at least one photosensitive detector,
at least one control circuit, and
at least one readout circuit.

The spectrometer system is a mixed spectrometer which employs the advantages of a scanning spectrometer and a dispersive spectrometer. Compared to both, the mixed spectrometer constitutes a simplified spectrometer system by including a reduced number of required components and exhibiting a miniaturized mechanical set-up.

### FIELD OF THE INVENTION

The invention relates to a spectrometer device and a method for measuring optical radiation as well as to a spectrometer system comprising the spectrometer device. Such devices, methods and systems can, in general, be used for investigation or monitoring purposes, in particular in the infrared (IR) spectral region, especially in the near-infrared (NIR) spectral region, as well as for a detection of heat, flames, fire, or smoke. However, further kinds of applications are possible.

### PRIOR ART

Spectroscopy exploits the fact that atoms and molecules comprised by a material absorb at least one specific wavelength which is characteristic of their structure. Thus, absorption spectroscopy is an important tool for material analytics. Herein, absorption can be measured by recording a reflected radiation from an object or by recording transmitted radiation through the object, wherein the object comprises the material under investigation. Most commonly, for liquids and gases the transmission spectroscopy is used, while the reflection spectroscopy is employed for solids.

Independent whether a reflection type or a transmission type is used, spectral information can be resolved in a spectrometer device by employing one of two different approaches:
Firstly, in a so-denoted “scanning spectrometer” a range of wavelengths provided by the light source to the detector can be scanned, in particular by using at least one transfer element, which may, specifically, be selected from at least one of a movable dispersive element, a tunable filter, or a rotating grating. As a result, the detector can record each wavelength in a sequential fashion. Herein, a single detector can be sufficient in most cases. Alternatively, a scanning spectrometer which is based on interference of different wavelengths can be employed. After recoding, the spectrum can be reconstructed using Fourier transformation. By way of example, a Michelson Interferometer can be employed as scanning spectrometer.
Secondly in a so-denoted “dispersive spectrometer”, all the discrete wavelengths can be recorded at the same time by using a multi-pixel detector, for example a detector array, such as a detector matrix. Herein, at least one dispersive element, preferably selected from at least one of a prism, a grating, or a linearly variable filter (LVF), is employed. Spectrometers of this type are, e.g., disclosed in US 2014/131578 A1, WO 2019/115594 A1, WO 2019/115595 A1, or WO 2019/115596 A1.

Typically, the scanning spectrometer comprises a single detector, whereby, on one hand, a read-out electronics can be simplified, thus, reduces the cost of the scanning spectrometer. However, on the other hand, an optical part of the scanning spectrometer is, typically, more complicated, in particular by employing the at least one transfer element as described above. As a result, total costs of optical components for the optical part of the scanning spectrometer can add up.

In contrast, the dispersive spectrometer does not comprise a scanning element. Thus, on one hand, the optical part of the dispersive spectrometer can be simplified. However, on the other hand, the detector array which is comprised by the dispersive spectrometer requires a more complex read-out electronics. Furthermore, the detector array is, typically, much more expensive compared to a single detector. As a result, total costs of detector arrays, and complex read-out electronics as required for the dispersive spectrometer can add up. Further, it is much more difficult, in general, to miniaturize the optical part and, if applicable, an optoelectronic part of the dispersive spectrometer.

Further, it is known that optical detectors which are sensitive in the IR spectral region, in particular optical detectors which comprise at least one photoconductive material, constitute detector systems which are dominated by noise. Therefore, an increase of an incident radiant power onto a photosensitive region as comprised by the optical detector results in an improved signal-to-noise ratio of the optical detector. However, at least one dispersive element is, disadvantageously, capable of reducing the incident radiant power to the photosensitive region of the optical detector, independent of the approach used for the spectrometer system. Further, the at least one dispersive element has at least one entrance slit and may have at least one exit slit, which can, further, limit the amount of radiation which may pass through the at least one dispersive element.

EP 3 318 854 A1 discloses a spectrometer comprised by an apparatus for measuring biometric information, such as a fitness wrist band which can be connected to a smartphone or a tablet. The spectrometer comprises light sources which emit near-infrared light. Further, the spectrometer comprises wavelength controllers configured as temperature control members, which control the peak wavelength by adjusting the temperature. A controller sets an individual peak wavelength for each of the light sources and controls the light sources by adjusting the current intensity or the pulse duration, thereby reconstructing a spectrum based on an optical signal using a Tikhonov regularization method and a reference spectrum.

WO 2016/191307 A1 discloses an optical physiological sensor configured to perform high-speed spectral sweep analysis of a sample tissue. The sensor may be comprised by a data collection system and configured to irradiate visible and/or infrared light to a sample tissue and to, subsequently, detect it. The sensor comprises an emitter and a thermal controller including a temperature sensor and a thermoelectric cooler, which can be reversed to increase the temperature of the emitter. The thermal controller communicates with a high-speed data collection board/front end interface which is connected to processors and storage devices. The data collection system further comprises tissue light detectors which measure the light intensity through the tissue. The thermal controller can, further, regulate the detector temperature. In a further embodiment, the sensor comprises indium gallium arsenide as active material.

WO 2009/030812 A1 discloses an infrared spectrometer comprising a radiation source, a modulating device for producing time-modulated irradiance on a sample, optical devices, such as lenses or mirrors, an optical light guide and a sensor module having a window, a variable filter, a linear detector array and a PI controller. On a backside of the sensor module are means for cooling and temperature stabilization of the detector array and the linear variable filter. Linear detector arrays are widely available with integrated cooling devices for optimizing the signal-to-noise performance, and the linear variable filter can be integrated in the temperature controlled volume. In an embodiment, photoconductive HgCdTe arrays are used as linear detector arrays and cooled into operating temperatures for optimum performance. The cooling device is regulated by using a feedback from a temperature sensor attached to the detector array. This feedback is provided to a temperature controller and is used to adjust the cooling or heating function of the temperature stabilization device.

### Problem Addressed by the Invention

Therefore, the problem addressed by the present invention is that of providing a spectrometer device and a method for measuring optical radiation as well as a spectrometer system which may, particularly, be suited for investigations in the infrared (IR) spectral region, especially in the near-infrared (NIR) spectral region, and which at least substantially avoid the disadvantages of known devices and systems of this type.

In particular, it would be desirous to have an improved simple, cost-efficient and, still, reliable spectrometer device which comprises a reduced numbers of required components and, further, allows miniaturizing a mechanical and optical set-up.

### SUMMARY OF THE INVENTION

This problem is solved by the invention with the features of the independent patent claims. Advantageous developments of the invention, which can be implemented individually or in combination, are presented in the dependent claims and/or in the following specification and the detailed embodiments.

As used herein, the expressions “have”, “comprise” and “contain” as well as grammatical variations thereof are used in a non-exclusive way. Thus, the expression “A has B” as well as the expression “A comprises B” or “A contains B” may both refer to the fact that, besides B, A contains one or more further components and/or constituents, and to the case in which, besides B, no other components, constituents or elements are present in A.

In a first aspect of the present invention, a spectrometer device for measuring optical radiation is disclosed. Accordingly, the spectrometer device comprises
at least one radiation emitting element, wherein the at least one radiation emitting element is designed for emitting optical radiation, wherein a spectrum of the emitted optical radiation is dependent on a temperature of the radiation emitting element;
at least one photosensitive detector, wherein the at least one photosensitive detector has at least one photosensitive region designated for receiving the emitted optical radiation, wherein at least one detector signal generated by the at least one photosensitive detector is dependent on an illumination of the at least one photosensitive region and on the temperature of the at least one photosensitive detector;
at least one control circuit, wherein the at least one control circuit is configured for
   determining the spectrum of the emitted optical radiation by the at least one radiation emitting element by using Planck's law with a known temperature, and
   adjusting the temperature of at least one of the at least one radiation emitting element or the at least one photosensitive detector by applying at least one control signal to the at least one of the at least one radiation emitting element or to the at least one photosensitive detector;
at least one readout circuit, wherein the at least one readout circuit is configured for measuring the at least one detector signal as generated by the at least one photosensitive detector.

As used herein, the term “radiation”, generally, refers to a partition of electromagnetic radiation which is, usually, referred to as “optical spectral range” and which comprises one or more of the visible spectral range, the ultraviolet spectral range, and the infrared spectral range. The term “ultraviolet spectral range”, generally, refers to electromagnetic radiation having a wavelength of 1 nm to 380 nm, preferably of 100 nm to 380 nm. Further, the term “visible spectral range”, generally, refers to a spectral range of 380 nm to 760 nm. Further, the term “infrared spectral range” (IR) generally refers to electromagnetic radiation of 760 nm to 1000 μm, wherein the spectral range of 760 nm to 3 μm is, usually, denominated as “near infrared spectral range” (NIR). Preferably, the radiation which is used for the typical purposes of the present invention is in the infrared (IR) spectral range, more preferred, in the near infrared (NIR), especially having a wavelength of 760 nm to 3 μm, preferably of 1 μm to 3 μm.

In general, radiation which is emerging from an object can originate in the object itself, but may have a different origin and propagate from this origin to the object and subsequently toward the spectrometer device. According to the present invention, the latter case is affected by at least one radiation emitting element which is designed for emitting the radiation. Thus, the radiation propagating from the object to the spectrometer device may be radiation which may be reflected by the object and/or a reflection device connected to the object. Alternatively or in addition, the radiation may at least partially transmit through the object. The “object” may, generally, be an arbitrary body, chosen from a living object and a non-living object which comprises material under investigation by the spectrometer device. Thus, as an example, the at least one object may comprise one or more articles and/or one or more parts of an article, wherein the at least one article or the at least one part thereof may comprise at least one component which may provide a spectrum that may be suitable for investigations. Additionally or alternatively, the object may be or may comprise one or more living beings and/or one or more parts thereof, in particular one or more body parts of a human being, e.g. a user, and/or an animal.

The spectrometer device according to the present invention comprises at least one radiation emitting element which can be embodied in various ways. The at least one radiation emitting element can be part of the spectrometer device in a housing. Alternatively or additionally, the at least one radiation emitting element can also be arranged outside a housing, e.g. as a separate radiation emitting element. The at least one radiation emitting element can be arranged separately from the object and illuminate the object from a distance. Alternatively or in addition, the at least one radiation emitting element can be connected to the object or be part of the object in a fashion that the radiation emerging from the object can directly be generated by the at least one radiation emitting element. By way of example, the at least one radiation emitting element can be arranged on and/or in the object and directly generate the radiation.

The at least one radiation emitting element may be configured to provide sufficient emission in the infrared (IR) spectral range, preferably in the near infrared (NIR) spectral range, especially a wavelength of 760 nm to 3 μm, preferably of 1 μm to 3 μm. The at least one radiation emitting element may, in particular, be comprised by a thermal radiator, specifically an incandescent lamp or a thermal infrared emitter. As generally used, the terms “incandescent lamp”, “incandescent light bulb” or “incandescent light globe” relate to a device having a volume confined by a bulb, in particular of glass or fused quartz, wherein a wire filament, which may, specifically, comprise tungsten, is located as the radiation emitting element in the volume, preferably filled with inert gas or comprising a vacuum, where it emits the optical radiation to be monitored. As further used herein, the term “thermal infrared emitter” refers to a micro-machined thermally emitting device which comprises a radiation emitting surface as the radiation emitting element that emits the optical radiation to be monitored. Specifically, thermal infrared emitters are available as “emirs50” from Axetris AG, Schwarzenbergstrasse 10, CH-6056 Kägiswil, Switzerland, as “thermal infrared emitters” from LASER COMPONENTS GmbH, Werner-von-Siemens-Str. 15 82140 Olching, Germany, or as “infra-red emitters” from Hawkeye Technologies, 181 Research Drive #8, Milford Conn. 06460, United States. Further types of thermal infrared emitters may also be feasible.

The radiation emitting element, i.e. the wire filament of the incandescent lamp or the radiation emitting surface of the thermal infrared emitter, is designated to be impinged by an electrical current in a fashion that a heating thereof results in emitting a considerable amount of radiation. It may be preferred when the radiation emitted by the at least one radiation emitting element may exhibit a spectral range which may be closely related to the spectral sensitivities of the at least one photosensitive detector, particularly, in a manner to ensure that the at least one photosensitive detector which may be illuminated by the at least one radiation emitting element may be capable of providing a detector signal of high intensity, enabling an evaluation of the detector signals with sufficient signal-to-noise-ratio and, concurrently, a high-resolution.

The at least one radiation emitting element may be a continuous light source or, alternatively, a pulsed light source, wherein the pulsed light source may have a modulation frequency of at least 1 Hz, of at least 5 Hz, of at least 10 Hz, of at least 50 Hz, of at least 100 Hz, of at least 500 Hz, of at least 1 kHz, or more. For driving the pulsed light source, a modulation device can be used, which may be designated for modulating the illumination, preferably by generating a periodic modulation. As generally used, the term “modulation” refers a process in which a total power of the illumination is varied, preferably periodically, in particular with at least one modulation frequency. In particular, a periodic modulation can be effected between a maximum value and a minimum value of the total power of the illumination. The minimum value can be 0, but can also be >0, such that, by way of example, complete modulation does not have to be effected. The modulation can, preferably, be effected within the light source designated for generating the desired modulated illumination, preferably, by the at least one radiation emitting element itself having a modulated intensity and/or total power, for example a periodically modulated total power, and/or by the at least one radiation emitting element being embodied as a pulsed light source, for example as a pulsed laser. As a further example, European patent application 19 21 32 77.7, filed Dec. 3, 2019, discloses at least one radiation emitting element which is designated for generating radiation upon being heated by an electrical current; a mount, wherein the mount carries the at least one radiation emitting element, and wherein the mount or a portion thereof is movable; and a heat sink, wherein the heat sink is designated for cooling the mount and the at least one radiation emitting element being carried by the mount upon being touched by the mount. Alternatively or additionally, a different type of modulation device, for example, a modulation device based on an electro-optical effect and/or an acousto-optical effect, can also be used. Further, a periodic beam interrupting device, in particular a beam chopper, an interrupter blade or an interrupter wheel, which may, preferably, rotate at constant speed to periodically interrupt the illumination, can also be used. In a particular embodiment, at least one photosensitive detector as described below in more detail which is designated for generating at least one detector signal for each different modulation frequency can be used. In this embodiment, an evaluation unit as described below in more detail can be designated for generating the spectral information from the at least one detector signal for each different modulation frequency.

As further used herein, the term “spectrum” refers to a partition of the optical spectral range, in particular of the infrared (IR) spectral range, preferably in the near infrared (NIR) spectral range, especially of 760 nm to 3 μm, preferably of 1 μm to 3 μm. Each part of the spectrum is constituted by an optical signal which is defined by a signal wavelength and the corresponding signal intensity. Further, the term “spectrometer device” relates to an apparatus which is capable of recording the signal intensity with respect to the corresponding wavelength of a spectrum or a partition thereof, in particular a wavelength interval, wherein the signal intensity may, preferably, be provided as at least one detector signal which can be used for further evaluation. As further used herein, a “spectrometer system” refers to an apparatus which, in addition to the spectrometer device, comprises an evaluation unit which is designated for determining information related to a spectrum of an object by evaluating the at least one detector signal provided by the spectrometer device as disclosed herein.

Further according to the present invention, the spectrometer device comprises at least one photosensitive detector. As generally used, the term “photosensitive detector” refers to an optical detector which comprises at least one photosensitive region that is, depending on the illumination of the at least one photosensitive region, designated for generating at least one detector signal, wherein the at least one detector signal may, in particular, be provided to at least one readout circuit for measuring and/or to an external evaluation unit for evaluation. The at least one photosensitive region as comprised by the at least one photosensitive detector may, preferably, be a single, uniform photosensitive area which is configured for receiving the emitted optical radiation that impinges on the photosensitive area. The at least one photosensitive detector is designated for generating detector signals, preferably optical or electronic signals, which are associated with the intensity of the emitted optical radiation that impinges on the at least one photosensitive detector. The detector signal may be an analogue and/or a digital signal. In a particular embodiment, the at least one photosensitive detector may be or comprise an active sensor which is adapted to amplify the electronic signals prior to providing it, for example, to the external evaluation unit. For this purpose, the at least one photosensitive detector may comprise one or more signal processing devices, in particular one or more filters and/or analogue-digital-converters for processing and/or preprocessing the electronic signals.

The at least one photosensitive detector can be selected from any known optical sensor, in particular from an inorganic camera element, preferably from an inorganic camera chip, more preferred from a CCD chip or a CMOS chip, which are, commonly, used in various cameras nowadays. As an alternative, the at least one photosensitive detector, in particular the at least one photosensitive region, may comprise a photoconductive material, in particular an inorganic photoconductive material, especially selected from lead sulfide (PbS), lead selenide (PbSe), germanium (Ge), indium gallium arsenide (InGaAs, including but not limited to ext. InGaAs), indium antimonide (InSb), or mercury cadmium telluride (HgCdTe or MCT). As generally used, the term “ext. InGaAs” refers to a particular type of InGaAs which exhibits a spectral response up to 2.6 μm. However, further kinds of photoconductive materials may also be feasible.

As a further alternative, the at least one photosensitive detector may be or comprise a pyroelectric detector element, a bolometric detector element, or a thermopile detector element. As a further alternative, the at least one photosensitive detector may be or comprise a FIP sensor element which is, e.g., disclosed in WO 2012/110924 A1, WO 2014/097181 A1, or WO 2016/120392 A1. The term “FIP sensor” refers to a sensor in which the sensor signal, given the same total power of the illumination, is dependent on a geometry of the illumination of the at least one photosensitive region, in particular on a beam cross-section of the illumination on the at least one photosensitive region. Preferably, the photosensitive region of the FIP sensor may comprise a photoconductive material, especially selected from the photoconductive materials as disclosed above, or a solid dye sensitized solar cell (sDSC).

Further according to the present invention, the spectrometer device comprises at least one readout circuit, wherein the at least one readout circuit is configured for measuring the at least one detector signal as generated by the at least one photosensitive detector. As generally used, the term “measuring” refers to recording at least one property related to the at least one detector signal, in particular at least one of an intensity, a current, a voltage, a resistance, a heat, a frequency, an electrical power, or a polarization of the at least one detector signal, or a time at which the at least one detector signal is recorded. However, a recording of further properties, whether associated with the at least one detector signal or not, may also be feasible. By way of example, a color, a mechanical expansion, or a temperature of the detector can be measured. As a further example, by using an optopneumatic detector a pressure or a gas flow can be measured. The at least one detector signal as measured by the at least one readout circuit as comprised by the spectrometer device can, subsequently, be forwarded to an external evaluation unit, in particular, to an evaluation unit that may be comprised by a corresponding spectrometer system as described below in more detail.

Further according to the present invention, the spectrometer device, comprises at least one control circuit which is configured for adjusting the temperature of at least one of the at least one radiation emitting element or the at least one photosensitive detector. In general, the at least one radiation emitting element and/or the at least one photosensitive detector operate in a fashion that their respective output, i.e. the spectrum of the emitted optical radiation in case of the at least one radiation emitting element, or the at least one detector signal in the case of the at least one photosensitive detector, is dependent on a temperature of the radiation emitting element or of the at least one photosensitive detector, respectively. The at least one radiation emitting element may radiate the radiation in a given spectrum band, whereas a wavelength interval and a shape of the spectrum, in particular a peak wavelength, may depend on at least one parameter of the at least one radiation emitting element.

In a particularly preferred embodiment, the radiation emitting element as comprised by the thermal radiator, in particular the incandescent lamp, may radiate a broadband spectrum, whereas the peak wavelength of the emission spectrum may be inversely proportional to a temperature of the thermal radiator according to the Wien's displacement law. By increasing a power which is applied to the incandescent lamp, the temperature of the incandescent lamp is increased, whereby, according to the Wien's displacement law, the peak wavelength of the emitted spectrum is decreased. Another example may refer to a plasma radiator, in particular a high-pressure plasma lamp, whereas the peak wavelength of its broadband continuum radiation can be adjusted by varying a plasma current which is applied to the plasma radiator. Using the at least one control circuit, the temperature of the at least one radiation emitting element can, successively, be adjusted, while the temperature of the at least one photosensitive detector can, preferably, maintained constant, whereby an alteration of the spectral response of the at least one radiation emitting element may be obtained, which can be used for scanning a particular wavelength region of the spectrum of a material under investigation.

In a similar fashion, a temperature dependency of the spectral response of the at least one photosensitive detector can be applied. Known photoconductive materials, in particular PbS, PbSe, Ge, InGaAs, InSb, or HgCdTe, have an energy gap which exhibits a negative temperature coefficient. By cooling the photoconductive material, its spectral response and, in particular, the corresponding peak wavelength shifts to longer wavelengths. Using the at least one control circuit, the temperature of the at least one photosensitive detector can be adjusted, which results in an alteration of the spectral response of the at least one photosensitive detector. Thus, it is feasible to scan a particular wavelength region by controlling the temperature of the at least one photosensitive detector while maintaining the temperature of the at least one radiation emitting element constant.

In a particular embodiment, the spectrum of the radiation emitting element can be described in an analytical fashion as a function of its temperature. As generally known, the spectrum of the at least one radiation emitting element, in particular of the thermal radiator, specifically of the incandescent lamp, can be determined by applying Planck's law with a known temperature. By way of example, the temperature of the at least one radiation emitting element, in particular of the thermal radiator, specifically of the incandescent lamp, can be monitored by at least one of:
measuring a power being absorbed by the at least one radiation emitting element;
measuring a voltage and/or a current flowing through the at least one radiation emitting element;
measuring an internal electrical resistance of the at least one radiation emitting element;
measuring a time the at least one radiation emitting element is operating; or
using a non-contact temperature sensor, preferably at least one of a pyrometer, a bolometer or a thermopile.

In the at least one radiation emitting element, in particular the thermal radiator, specifically the incandescent lamp, the temperature of the at least one radiation emitting element may be adjusted by applying at least one parameter, in particular at least one electrical parameter, preferably a voltage and/or a current, to the at least one radiation emitting element. According to Wien's displacement law, the peak wavelength of the emission spectrum of the at least one radiation emitting element shifts. In this manner, the at least one radiation emitting element which is or comprises a broadband thermal radiator, specifically an incandescent lamp, can used as a tunable wavelength scanner.

In a further embodiment, a calibration step can be performed, in addition or alternatively, in particular for a radiation emitting element whose spectrum cannot be described in an analytical fashion as a function of its temperature. For performing the calibration step, the spectrum of the radiation emitting element can be measured and stored as reference in form of a function of the at least one parameter, in particular the at least one electrical parameter, related to the radiation emitting element. A look-up table can be used for storing a relationship between the temperature of the radiation emitting element and the at least one parameter, in particular the at least one electrical parameter, applied to the at least one radiation emitting element. By way of example, a plasma current through a plasma radiator, in particular a high-pressure plasma lamp, can be varied while the spectrometer device measures emission spectra of the plasma radiator, whereinafter selected parameters can be stored as calibration file, preferably in form of a look-up table, for the plasma radiator for further reference.

As indicated above, the at least one control circuit is configured for adjusting the temperature of the at least one radiation emitting element and/or the at least one photosensitive detector, wherein adjusting the temperature of the at least one radiation emitting element while maintaining the temperature of the at least one photosensitive detector is particularly preferred. For this purpose, the at least one control circuit may comprise at least one of a current source, a voltage source, a power source, or a pulse source which are designated for generating a current, a voltage, or an adjustable dissipated power, respectively, which are applied to the at least one radiation emitting element, and/or, if desired, to the at least one photosensitive detector. In addition, the at least one control circuit may further comprise at least one of a current amplifier, a current delimiter, a voltage amplifier, or a voltage delimiter. Other or further parts are possible.

The radiation which is generated by the at least one radiating emitting element can, preferably, be directed to an object in such a fashion that diffuse reflection may occur. A diffuse reflection spectrum which is generated by the reflected radiation of the object carries a spectral fingerprint of the material comprised by the object or at least a surface portion thereof. The reflected radiation is, subsequently, collected by the at least one photosensitive detector. Since neither the spectrometer device nor the photosensitive detector comprises a dispersive element, the at least one detector signal as generated by the photosensitive detector is depending on
an emission spectrum of the at least one radiation emitting element;
a spectral integral of a whole diffuse reflection spectrum; and
a spectral sensitivity spectrum of the at least one photosensitive detector.

In particular, the spectral sensitivity of the at least one photosensitive detector may, preferably, be covered by a spectral range of the at least one radiation emitting element.

For every temperature of the at least one radiation emitting element, which may correspond to a current and/or a voltage applied to the incandescent lamp, or to a plasma current in the plasma radiator, which corresponds to a peak wavelength in the spectrum, a detector signal is measured by the at least one photosensitive detector. Not wishing to be bound by theory, this kind of procedure can analytically be described by Equation (1) as follows:

$$( \begin{matrix}{E}_{λ 1}^{T 1} & … & {E}_{λ n}^{T 1} \\ ⋮ & ⋱ & ⋮ \\ {E}_{λ 1}^{Tm} & … & {E}_{λ n}^{Tm}\end{matrix} ) \times ( \begin{matrix}{R}_{λ 1} \\ ⋮ \\ {R}_{λ n}\end{matrix} ) = ( \begin{matrix}{S}^{T 1} \\ ⋮ \\ {S}^{Tm}\end{matrix} ) , \qquad ( 1 )$$

wherein E_{λn}^{Tm} is an n^{th} wavelength component of the emission spectrum at the m^{th} temperature Tₘ. Further, R_{λN} is the n^{th} wavelength component of the reflection spectrum while S^{Tm} is the detector signal at the m^{th} temperature Tₘ.

If the temperature of the at least one radiation emitting element is known, the emission spectrum at this temperature can be calculated using Planck's law. Further, the at least one detector signal is measured. As a result, the linear Equation (2)

E·R=S (2)

can be solved as follows as Equation (3):

R=E⁻¹·S. (3)

Consequently, the absorption spectrum R of the object can be determined by using only a single incandescent lamp as the radiation emitting element and a single photosensitive detector without employing any further optical components.

A similar approach can be applied for transmission measurement. Instead of using the absorption spectrum R of the object, an absorption spectrum A of the object can be determined by measuring the transmitted radiation from the at least one radiation emitting element through the object to the photosensitive detector.

Since the thermal radiator has a broadband emission spectrum, the resolution of the absorption spectrum as determined in this fashion is relatively low, especially if compared to a dispersive spectrometer. In a particular embodiment, the resolution of the absorption spectrum can be improved by using a photosensitive detector having at least two photosensitive regions, preferably two, three, four, five, six, seven, or eight photosensitive regions, or, alternatively or in addition, by using at least two individual photosensitive detectors, preferably two, three, four, five, six, seven, or eight photosensitive detectors. In general, the number of the photosensitive detectors and/or photosensitive regions can be increased until the desired resolution is reached, however, at cost of increasing complexity of and expenses for the particular spectrometer device, such that a maximum of four, six or eight photosensitive detectors or photosensitive regions may particularly be preferred. The at least two photosensitive detectors or at least two photosensitive regions can be different but may, preferably, be identical, thus, facilitating provision and reading of the at least one photosensitive detector.

The at least one photosensitive detector comprising the at least one photosensitive region can be equipped with at least one optical pass filter, specifically selected from at least one of an optical short pass filer, an optical long pass filter, or an optical band pass filter. In a particularly preferred embodiment comprising at least two photosensitive detectors and/or at least two photosensitive regions, each photosensitive detector and/or each photosensitive region can be equipped with a different optical pass filter, thus, being configured for sampling a different part of the absorption spectrum. By way of example, a first optical pass filter can be placed in front of a first photosensitive region while a second optical pass filter can be placed in front of a second photosensitive region, wherein the first optical pass filter is designated for transmitting radiation having a wavelength of a first wavelength range while the second optical pass filter is designated for transmitting radiation having a wavelength of a second wavelength range such that the first photosensitive region is configured for sampling a first part of the absorption spectrum while the second photosensitive region is configured for sampling a second part of the absorption spectrum, wherein the first wavelength range and the second wavelength range differ from each other but may, preferably, comprise adjacent wavelength ranges, such that a single combined absorption spectrum can be sampled. Further examples are presented below, in particular an example in which four different optical pass filters are arranged in front of four photosensitive regions, which may preferably, be identical. The different parts of the absorption spectrum as recorded by each photosensitive region can be assembled in order to obtain the desired absorption spectrum of the object over a larger wavelength range.

In a further aspect of the present invention, a spectrometer system is disclosed. Accordingly, the spectrometer system comprises
a spectrometer device as described above and/or below in more detail; and
an evaluation unit designated for determining information related to a spectrum of an object by evaluating at least one detector signal as provided by the spectrometer device.

The components of the spectrometer system as listed above may be individual components. Alternatively, two or more of the components of the spectrometer system may be integrated into a single integral component. Further, the evaluation unit may be formed as an individual unit independent from the spectrometer device but may, preferably, be connected to the at least one readout circuit, in particular to receive the at least one detector signal as measured by the at least one readout circuit as comprised by the spectrometer device. Alternatively, the at least one evaluation unit may fully or partially be integrated into the at least one spectrometer device.

According to the present invention, the spectrometer system comprises a spectrometer device and an evaluation unit. With respect to the spectrometer device, reference may be made to the description elsewhere in this document. The term “evaluation unit” refers to an apparatus being designated for determining spectral information, i.e. information which is related to the spectrum of the object of which a spectrum has been recorded, in particular, by using the spectrometer device as described herein, wherein the information is obtained by evaluating the at least one detector signal provided by the at least one readout circuit configured for measuring the at least one detector signal as generated by the at least one photosensitive detector. The evaluation unit may be or may comprise one or more integrated circuits, in particular at least one of an application-specific integrated circuit (ASIC), and/or a data processing device, in particular at least one of a digital signal processor (DSP), a field programmable gate arrays (FPGA), a micro-controller, a microcomputer, or a computer. Alternatively or in addition, the evaluation unit may, particularly, be or be comprised by at least one electronic communication unit, specifically a smartphone or a tablet. Additional components may be feasible, in particular one or more preprocessing devices and/or data acquisition devices, in particular one or more devices for receiving and/or preprocessing of the detector signals, in particular one or more AD-converters and/or one or more filters. Further, the evaluation unit may comprise one or more data storage devices, in particular for storing at least one electronic table, in particular at least one look-up table. Further, the evaluation unit may comprise one or more interfaces, in particular one or more wireless interfaces and/or one or more wire-bound interfaces.

The evaluation unit may, preferably, be configured to perform at least one computer program, in particular at least one computer program performing or supporting the step of generating the at least one item of spectral information. By way of example, one or more algorithms may be implemented which, by using the at least one detector signal as at least one input variable, may perform a transformation into a spectral information. For this purpose, the evaluation unit may, particularly, comprise at least one data processing device, in particular an electronic data processing device, which can be designed to generate the at least one item of information by evaluating the at least one detector signal. Thus, the evaluation unit is designed to use the at least one detector signal as the at least one input variable and to generate the spectral information by processing the at least one input variable. The processing can be done in parallel, subsequently or even in a combined manner. The evaluation unit may use an arbitrary process for generating the at least one item of spectral information, in particular by calculation and/or using at least one stored and/or known relationship.

Apart from at least one detector signal, one or a plurality of further parameters and/or items of information can influence said relationship, for example at least one item of information about the object, the at least one radiation emitting element, and the at least one photosensitive detector as comprised by the spectrometer device. The relationship can be determined empirically, analytically or else semi-empirically. Preferably, the relationship may comprise at least one calibration curve, at least one set of calibration curves, at least one function or a combination of the possibilities mentioned. One or a plurality of calibration curves can be stored for example in the form of a set of values and the associated function values thereof, for example in a data storage device and/or a table. Alternatively or additionally, however, the at least one calibration curve can also be stored for example in parameterized form and/or as a functional equation. Separate relationships for processing the detector signals into the at least one item of information may be used. Alternatively, at least one combined relationship for processing the at least one detector signal is feasible. Various possibilities are conceivable and can also be combined.

The evaluation unit can also be designed to, completely or partially, control or drive the spectrometer device or a part thereof, in particular by the evaluation unit being designed to control at least one of the at least one radiation emitting element, the at least one photosensitive detector, the at least one control circuit, or the at least one readout circuit. The evaluation unit can, in particular, be designed to carry out at least one measurement cycle in which a plurality of detector signals are picked up, especially, the detector signals for successively adjusted temperatures of at least one of the at least one radiation emitting element or the at least one photosensitive detector by driving the at least one control circuit. Herein, acquiring the detector signals can be performed sequentially, in particular, by using a temporal scan.

The information as determined by the evaluation unit may, in particular, be provided to at least one of a further apparatus or a user in at least one of an electronic, visual, or acoustic fashion. Further, the information may be stored in at least one data storage device, wherein the at least one data storage device may be comprised by the spectrometer system, in particular by the at least one evaluation unit, or wherein the at least one data storage device may be a separate storage device, wherein the information may be transmitted via at least one interface, in particular a wireless interface and/or a wire-bound interface.

In a further aspect of the present invention, a method for measuring optical radiation is disclosed. The method as disclosed herein comprises the following steps a) to d), which may, preferably, be performed in an order, commencing with step a), continuing with step c) and, then, step b), and finishing with step d), wherein some of the steps may, at least partially, be performed in a simultaneous manner. Further, additional steps not listed herein can be performed. The method for measuring optical radiation according to the present invention comprises the following steps:
a) emitting optical radiation using at least one radiation emitting element, wherein a spectrum of the emitted optical radiation is dependent on a temperature of the radiation emitting element;
b) generating at least one detector signal using at least one photosensitive detector, wherein the at least one photosensitive detector has at least one photosensitive region designated for receiving the emitted optical radiation, wherein the at least one detector signal is dependent on an illumination of the at least one photosensitive region and on the temperature of the at least one photosensitive detector;
c) determining the spectrum of the optical radiation emitted by the at least one radiation emitting element by using Planck's law with a known temperature, and adjusting the temperature of at least one of the at least one radiation emitting element or the at least one photosensitive detector by applying at least one control signal to the at least one of the at least one radiation emitting element or to the at least one photosensitive detector;
d) measuring the at least one detector signal as generated by the at least one photosensitive detector.

According to step a), optical radiation is emitted by using at least one radiation emitting element, in particular a radiation emitting element as described above or below in more detail, wherein a spectrum of the emitted optical radiation is dependent on a temperature of the radiation emitting element.

According to step b), at least one detector signal is generated by using at least one photosensitive detector, in particular a photosensitive detector as described above or below in more detail, wherein the at least one photosensitive detector has at least one photosensitive region which is designated for receiving the emitted optical radiation, and wherein the at least one detector signal is dependent on an illumination of the at least one photosensitive region and on the temperature of the at least one photosensitive detector.

According to step c), the spectrum of the optical radiation emitted by the at least one radiation emitting element is determined by using Planck's law with a known temperature, and the temperature of at least one of
the at least one radiation emitting element, and/or
the at least one photosensitive detector

is adjusted by applying at least one control signal to the at least one of the at least one radiation emitting element or to the at least one photosensitive detector. Preferably, the at least one control signal may be provided by at least one control circuit as described above or below in more detail. Preferably, step c) comprises adjusting the temperature of the at least one radiation emitting element or of the at least one photosensitive detector by providing the at least one control signal to the at least one radiation emitting element or to the at least one photosensitive detector.

According to step d), the at least one detector signal as which is generated by the at least one photosensitive detector is measured, in particular by using at least one readout circuit as described above or below in more detail.

In an optional evaluating step, desired spectral information which is related to a spectrum of the object can be determined by using the evaluation unit as described above or below in more detail, wherein the evaluating may, in particular, be based on the at least one detector signal, in particular as measured by the at least one readout circuit and, subsequently, provided to the evaluation unit.

In a further aspect, the present invention refers to computer program product, which comprises executable instructions which, when the program is executed by a computer, cause the computer to carry out the steps of the method for measuring optical radiation as described elsewhere herein. The computer program product comprising executable instructions may, preferably, fully or partially be integrated into the evaluation unit, in particular into an electronic communication unit, specifically a smartphone or a tablet, or the spectrometer device, in particular the at least one control circuit. The computer program product may be capable of performing the method using at least one data processing device already comprised by the spectrometer device or the evaluation unit, in particular the electronic communication unit, specifically the smartphone or tablet. By way of example, the method may be performed as an application, also denoted by the term “app”, on the electronic communication unit. Alternatively, the computer program product may be capable of performing the method by using the at least one control circuit already comprised by the spectrometer system. In addition, further kinds of electronic devices may also be conceivable.

In a further aspect of the present invention, a use of a spectrometer device and a spectrometer system according to the present invention is disclosed. Therein, the use of the spectrometer device and the spectrometer system for a purpose of determining information related to a spectrum of an object is proposed. Herein, the spectrometer device and the spectrometer system may, preferably, be used for a purpose of use, selected from the group consisting of: an infrared detection application; a spectroscopy application; an exhaust gas monitoring application; a combustion process monitoring application; a pollution monitoring application; an industrial process monitoring application; a mixing or blending process monitoring; a chemical process monitoring application; a food processing process monitoring application; a food preparation process monitoring; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application, in particular characterization of soil, silage, feed, crop or produce, monitoring plant health; a plastics identification and/or recycling application. Further applications are feasible.

For further details concerning the spectrometer system, the method for measuring optical radiation, the computer program product and the respective uses of the spectrometer device of the spectrometer system according to the present invention, reference may be made to the description of the spectrometer device for measuring optical radiation as provided elsewhere herein.

The above-described spectrometer device and method for measuring optical radiation as well the spectrometer system comprising the spectrometer device have considerable advantages over the prior art. The spectrometer device according to the present invention can be considered as a “mixed spectrometer” which uses the advantages of both approaches, i.e. the so-denoted “scanning spectrometer” and the so-denoted “dispersive spectrometer”, both as described above, thereby avoiding their respective disadvantages. Compared to both the scanning system and the dispersive spectrometer, the mixed spectrometer constitutes a simplified spectrometer system by comprising a reduced number of required components and exhibiting a miniaturized mechanical set-up.

Summarizing, in the context of the present invention, the following embodiments are regarded as particularly preferred:

Embodiment 1: A spectrometer device for measuring optical radiation, comprising:
at least one radiation emitting element, wherein the at least one radiation emitting element is designed for emitting optical radiation, wherein a spectrum of the emitted optical radiation is dependent on a temperature of the radiation emitting element;
at least one photosensitive detector, wherein the at least one photosensitive detector has at least one photosensitive region designated for receiving the emitted optical radiation, wherein at least one detector signal generated by the at least one photosensitive detector is dependent on an illumination of the at least one photosensitive region and on the temperature of the at least one photosensitive detector;
at least one control circuit, wherein the at least one control circuit is configured for adjusting the temperature of at least one of the at least one radiation emitting element or the at least one photosensitive detector by applying at least one control signal to the at least one of the at least one radiation emitting element or to the at least one photosensitive detector;
at least one readout circuit, wherein the at least one readout circuit is configured for measuring the at least one detector signal as generated by the at least one photosensitive detector.

Embodiment 2: The spectrometer device according to the preceding Embodiment, wherein the at least one control circuit is configured for adjusting the temperature of the at least one radiation emitting element or of the at least one photosensitive detector by providing the at least one control signal to the at least one radiation emitting element or to the at least one photosensitive detector, respectively.

Embodiment 3: The spectrometer device according to any one of the preceding Embodiments, wherein a peak wavelength of the emitted optical radiation is a function of temperature.

Embodiment 4: The spectrometer device according to any one of the preceding Embodiments, wherein a peak wavelength of the emitted optical radiation is a function of temperature according to Wien's displacement law.

Embodiment 5: The spectrometer device according to any one of the preceding Embodiments, wherein the temperature of the at least one radiation emitting element is a function of the at least one control signal applied to the at least one radiation emitting element.

Embodiment 6: The spectrometer device according to any one of the preceding Embodiments, wherein the spectrum of the radiation emitting element is described in an analytical fashion as a function of its temperature.

Embodiment 7: The spectrometer device according to any one of the preceding Embodiments, wherein the at least one control circuit is configured for determining the spectrum of the optical radiation emitted by the at least one radiation emitting element by using Planck's law with a known temperature.

Embodiment 8: The spectrometer device according to any one of the preceding Embodiments, wherein the at least one control circuit is configured for monitoring the temperature of the incandescent lamp by at least one of:
measuring a power being absorbed by the at least one radiation emitting element;
measuring a voltage and/or a current flowing through the at least one radiation emitting element;
measuring an internal electrical resistance of the at least one radiation emitting element;
measuring a time the at least one radiation emitting element is operating; or
using a non-contact temperature sensor, preferably at least one of a pyrometer, a bolometer or a thermopile.

Embodiment 9: The spectrometer device according to any one of the preceding Embodiments, wherein the at least one control circuit is configured for adjusting the temperature of the at least one radiation emitting element by applying at least one parameter to the at least one radiation emitting element.

Embodiment 10: The spectrometer device according to the preceding Embodiment, wherein the at least one parameter is at least one electrical parameter.

Embodiment 11: The spectrometer device according to the preceding Embodiment, wherein the at least one electrical parameter is selected from at least one of a voltage or a current.

Embodiment 12: The spectrometer device according to any one of the preceding Embodiments, wherein the at least one radiation emitting element is or comprises at least one thermal radiator.

Embodiment 13: The spectrometer device according to the preceding Embodiment, wherein the at least one thermal radiator is or comprises an incandescent lamp or a thermal infrared emitter.

Embodiment 14: The spectrometer device according to any one of the preceding Embodiments, wherein the at least one control circuit is configured for performing a calibration step.

Embodiment 15: The spectrometer device according to the preceding Embodiment, wherein the at least one control circuit is configured for performing the calibration step for a radiation emitting element whose spectrum cannot be described in an analytical fashion as a function of its temperature.

Embodiment 16: The spectrometer device according to any one of the two preceding Embodiments, wherein the at least one control circuit is configured for performing the calibration step by measuring the spectrum of the radiation emitting element and storing as reference in form of a function of the at least one parameter, in particular the at least one electrical parameter, related to the radiation emitting element.

Embodiment 17: The spectrometer device according to any one of the three preceding Embodiments, wherein the at least one control circuit is configured for performing a calibration step by using a look-up table for storing a relationship between the temperature of the radiation emitting element and the at least one parameter, in particular the at least one electrical parameter, applied to the at least one radiation emitting element.

Embodiment 18: The spectrometer device according to any one of the four preceding Embodiments, wherein the at least one control circuit is configured for performing a calibration step by varying a plasma current through a plasma radiator, in particular a high-pressure plasma lamp, while the spectrometer device measures emission spectra of the plasma radiator.

Embodiment 19: The spectrometer device according to the preceding Embodiment, wherein the at least one control circuit is configured for storing selected parameters as calibration file, preferably in form of a look-up table, for further reference.

Embodiment 20: The spectrometer device according to any one of the preceding Embodiments, wherein the least one photosensitive detector is selected from a known optical sensor, in particular from an inorganic camera element, preferably from an inorganic camera chip, more preferred from a CCD chip or a CMOS chip.

Embodiment 21: The spectrometer device according to any one of the preceding Embodiments, wherein the least one photosensitive detector, in particular the at least one photosensitive region, comprises at least one photoconductive material.

Embodiment 22: The spectrometer device according to the preceding Embodiment, wherein the at least one photoconductive material is selected from at least one of PbS, PbSe, Ge, InGaAs, InSb, or HgCdTe.

Embodiment 23: The spectrometer device according to any one of the preceding Embodiments, wherein the least one photosensitive detector is or comprises a pyroelectric detector element, a bolometric detector element, or a thermopile detector element.

Embodiment 24: The spectrometer device according to any one of the preceding Embodiments, wherein the least one photosensitive detector is or comprises a FIP sensor element.

Embodiment 25: The spectrometer device according to the preceding Embodiment, wherein the FIP sensor element comprises at least one photoconductive material selected from at least one of PbS, PbSe, Ge, InGaAs, InSb, or HgCdTe.

Embodiment 26: The spectrometer device according to any one of the preceding Embodiments, wherein at least one optical pass filter is placed in a radiation path in front of the at least one photosensitive detector.

Embodiment 27: The spectrometer device according to the preceding Embodiment, wherein at least one optical pass filter is selected from at least one of an optical short pass filer, an optical long pass filter, or an optical band pass filter.

Embodiment 28: The spectrometer device according to any one of the preceding Embodiments, wherein the spectrometer device comprises at least two up to eight photosensitive detectors.

Embodiment 29: The spectrometer device according to the preceding Embodiment, comprising two, three, four, five, six, seven, or eight photosensitive detectors.

Embodiment 30: The spectrometer device according to the preceding Embodiment, wherein different optical pass filters are placed in the radiation path in front of each photosensitive detector.

Embodiment 31: The spectrometer device according to any one of the preceding Embodiments, wherein the at least one photosensitive detector comprises at least two up to eight photosensitive regions.

Embodiment 32: The spectrometer device according to the preceding Embodiment, comprising two, three, four, five, six, seven, or eight photosensitive regions.

Embodiment 33: The spectrometer device according to the preceding Embodiment, wherein different optical pass filters are placed in the radiation path in front of each photosensitive region.

Embodiment 34: The spectrometer device according to any one of the four preceding Embodiments, wherein the different optical pass filters differ by a wavelength range of passing optical radiation.

Embodiment 35: The spectrometer device according to any one of the preceding Embodiments, wherein the at least one detector signal is depending on
an emission spectrum of the at least one radiation emitting element;
a spectral integral of a whole diffuse reflection spectrum; and
a spectral sensitivity spectrum of the at least one photosensitive detector.

Embodiment 36: The spectrometer device according to any one of the preceding Embodiments, wherein a spectral sensitivity of the at least one photosensitive detector is covered by a spectral range of the at least one radiation emitting element.

Embodiment 37: The spectrometer device according to any one of the preceding Embodiments, wherein the emitted optical radiation comprises a wavelength of 760 nm to 1000 μm (infrared spectral range).

Embodiment 38: The spectrometer device according to the preceding Embodiment, wherein the emitted optical radiation comprises a wavelength of 760 nm to 3 μm (near-infrared spectral range).

Embodiment 39: The spectrometer device according to the preceding Embodiment, wherein the emitted optical radiation comprises a wavelength of 1 μm to 3 μm.

Embodiment 40: The spectrometer device according to any one of the preceding Embodiments, wherein the at least one readout circuit is configured for performing at least one of a current measurement or a voltage measurement.

Embodiment 41: A spectrometer system, comprising
a spectrometer device according to any one of the preceding Embodiments; and
an evaluation unit designated for determining information related to a spectrum of an object by evaluating at least one detector signal as provided by the spectrometer device.

Embodiment 42: The spectrometer system according to the preceding Embodiment, wherein the evaluation unit is or is comprised by at least one electronic communication unit.

Embodiment 43: The spectrometer system according to the preceding Embodiment, wherein the at least one electronic communication unit is selected from a smartphone or a tablet.

Embodiment 44: The spectrometer system according to any one of the preceding Embodiments referring to a spectrometer system, wherein the evaluation unit is further designed to, completely or partially, control or drive the spectrometer device or a part thereof.

Embodiment 45: The spectrometer system according to any one of the preceding Embodiments referring to a spectrometer system, wherein the evaluation unit is further configured for controlling at least one of the at least one radiation emitting element, the at least one photosensitive detector, the at least one control circuit, or the at least one readout circuit.

Embodiment 46: The spectrometer system according to any one of the preceding Embodiments referring to a spectrometer system, wherein the information as determined by the evaluation unit is provided to at least one of a further apparatus or a user in at least one of an electronic, visual, or acoustic fashion.

Embodiment 47: The spectrometer system according to any one of the preceding Embodiments referring to a spectrometer system, wherein the information as determined by the evaluation unit is stored in at least one data storage device.

Embodiment 48: The spectrometer system according to the preceding Embodiment, wherein the at least one data storage device is comprised by the spectrometer system, in particular by the at least one evaluation unit.

Embodiment 49: The spectrometer system according to any one of the two preceding Embodiments, wherein the at least one data storage device is a separate storage device.

Embodiment 50: The spectrometer system according to the preceding Embodiment, wherein the separate storage device is comprised by the at the least one electronic communication unit.

Embodiment 51: The spectrometer system according to the two preceding Embodiments, wherein the information is transmitted to the separate storage device via at least one interface, in particular a wireless interface and/or a wire-bound interface.

Embodiment 52: A method for measuring optical radiation, the method comprising the following steps:
a) emitting optical radiation using at least one radiation emitting element, wherein a spectrum of the emitted optical radiation is dependent on a temperature of the radiation emitting element;
b) generating at least one detector signal using at least one photosensitive detector, wherein the at least one photosensitive detector has at least one photosensitive region designated for receiving the emitted optical radiation, wherein the at least one detector signal is dependent on an illumination of the at least one photosensitive region and on the temperature of the at least one photosensitive detector;
c) adjusting the temperature of at least one of the at least one radiation emitting element or the at least one photosensitive detector by applying at least one control signal to the at least one of the at least one radiation emitting element or to the at least one photosensitive detector;
d) measuring the at least one detector signal as generated by the at least one photosensitive detector.

Embodiment 53: The method according to the preceding Embodiment, wherein the temperature of the at least one radiation emitting element or of the at least one photosensitive detector is adjusted by providing the at least one control signal to the at least one radiation emitting element or to the at least one photosensitive detector, respectively.

Embodiment 54: The method according to any one of the preceding Embodiments referring to a method, wherein a peak wavelength of the emitted optical radiation is shifted by adjusting the temperature of the at least one radiation emitting element.

Embodiment 55: The method according to the preceding Embodiment, wherein the peak wavelength as a function of the temperature of the at least one radiation emitting element is known analytically or is determined by applying a calibration process.

Embodiment 56: The method according to any one of the preceding Embodiments referring to a method, wherein the emitted optical radiation reaches the at least one photosensitive detector by at least one of being reflected by an object or being transmitted through the object.

Embodiment 57: The method according to any one of the preceding Embodiments referring to a method, wherein spectral information which is related to a spectrum of the object is determined by using an evaluation unit.

Embodiment 58: The method according to the preceding Embodiment, wherein the evaluating is based on the at least one detector signal as measured by the at least one readout circuit and, subsequently, provided to the evaluation unit.

Embodiment 59: A computer program product comprising instructions which, when the program is executed by a computer, cause the computer to carry out the steps of the method for measuring optical radiation.

Embodiment 60: A use of a spectrometer device according to any one of the preceding Embodiments referring to a spectrometer device or to a spectrometer system, for a purpose of use, selected from the group consisting of: an infrared detection application; a spectroscopy application; an exhaust gas monitoring application; a combustion process monitoring application; a pollution monitoring application; an industrial process monitoring application; a mixing or blending process monitoring; a chemical process monitoring application; a food processing process monitoring application; a food preparation process monitoring; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application, in particular characterization of soil, silage, feed, crop or produce, monitoring plant health; a plastics identification and/or recycling application.

### BRIEF DESCRIPTION OF THE FIGURES

Further optional details and features of the invention are evident from the description of preferred exemplary embodiments which follows in conjunction with the dependent claims. In this context, the particular features may be implemented alone or with features in combination.

The invention is not restricted to the exemplary embodiments. The exemplary embodiments are shown schematically in the figures. Identical reference numerals in the individual figures refer to identical elements or elements with identical function, or elements which correspond to one another with regard to their functions.

Specifically, in the figures:

FIG. 1 shows a schematic view of an exemplary embodiment of a spectrometer system comprising a spectrometer device according to the present invention, wherein a single photosensitive detector comprises a single photosensitive region (FIG. 1A), two individual photosensitive regions (FIG. 1B), and four individual photosensitive regions (FIG. 1C), respectively;

FIG. 2 shows a schematic view of an exemplary embodiment of a method for measuring optical radiation according to the present invention;

FIG. 3 shows an exemplary reflection spectrum of canola seed (prior art);

FIG. 4 shows emission spectra of an incandescent lamp for varying temperatures (prior art);

FIG. 5 shows a course of detectors signals generated by a photosensitive detector for varying temperatures of the incandescent lamp;

FIG. 6 shows a comparison of calculated and measured reflection spectra of canola seed obtained using a single photosensitive detector;

FIG. 7 shows a further comparison of the calculated and the measured reflection spectra of canola seed obtained using two individual photosensitive detectors; and

FIG. 8 shows a further comparison of the calculated and the measured reflection spectra of canola seed obtained using four individual photosensitive detectors.

### EXEMPLARY EMBODIMENTS

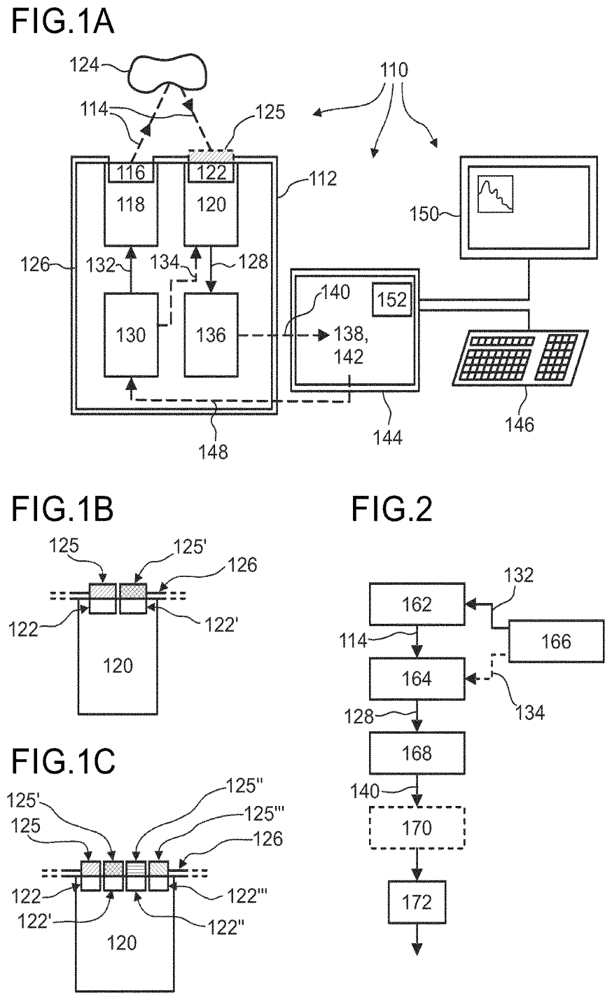

FIG. 1 illustrates, in a highly schematic fashion, an exemplary embodiment of a spectrometer system 110 which comprises a spectrometer device 112 according to the present invention. As generally used, the spectrometer device 112 is an apparatus which is capable of recording a signal intensity of an emitted optical radiation 114 with respect to a corresponding wavelength or a wavelength interval of the emitted optical radiation 114 over a range of wavelength which is denoted as a spectrum. According to the present invention, the spectrometer device 112 may, especially, be adapted for recording a spectrum in the infrared (IR) spectral region, preferably, in the near-infrared (NIR), especially, wherein the incident light may have a wavelength of 760 nm to 3 μm, preferably of 1 μm to 3 μm, and can, thus, be used for investigation or monitoring purposes, in particular in the infrared (IR) spectral region, especially in the near-infrared (NIR) spectral region, as well as for a detection of heat, flames, fire, or smoke. However, further applications may also be feasible.

The exemplary spectrometer device 112 as schematically depicted in FIG. 1 comprises a radiation emitting element 116 which is designed for the emitting optical radiation 114. In particular, the radiation emitting element 116 may be comprised by a thermal radiator 118, specifically an incandescent lamp or a thermal infrared emitter. Herein, the incandescent lamp has a volume confined by a bulb, in particular of glass or fused quartz, wherein a wire filament, specifically, comprising tungsten, is located as the radiation emitting element 116 in the volume, preferably filled with inert gas or comprising a vacuum. Alternatively, the thermal infrared emitter is a micro-machined thermally emitting device which comprises a radiation emitting surface as the radiation emitting element 116. For further details thereto, reference can be made to the description above. Further types of thermal infrared emitters may also be feasible.

The radiation emitting element 116 may be continuously emitting or, alternatively, generating modulated optical pulses. The modulation can, preferably, be effected within the radiation emitting element 116 itself having a modulated intensity and/or total power, for example a periodically modulated total power, and/or by the radiation emitting element 116 being embodied as a pulsed light source, for example as a pulsed laser. For a further example, reference can be made to European patent application 19 21 32 77.7, filed Dec. 3, 2019 which discloses a mount carrying the radiation emitting element 116, wherein the mount or a portion thereof is movable, and a heat sink, wherein the heat sink is designated for cooling the mount and the radiation emitting element 116 upon being touched by the mount. A further type of modulation device, e.g. based on an electro-optical effect and/or an acousto-optical effect, can also be used. Further, a periodic beam interrupting device, in particular a beam chopper, an interrupter blade or an interrupter wheel, preferably, rotating at constant speed to periodically interrupt the illumination, may also be feasible for generating the modulation.

The spectrum of the emitted optical radiation 114 is dependent on a temperature of the radiation emitting element 116. In a particularly preferred embodiment, the radiation emitting element 116 may radiate a broadband spectrum, whereas the peak wavelength of the emission spectrum may be inversely proportional to a temperature of the thermal radiator 118 comprising the radiation emitting element 116 according to the Wien's displacement law. By increasing a power which is applied to the incandescent lamp, the temperature of the incandescent lamp is increased, whereby, according to the Wien's displacement law, the peak wavelength of the emitted spectrum is decreased. As an alternative, a plasma radiator, in particular a high-pressure plasma lamp, may also be used, whereas the peak wavelength of its broadband continuum radiation can be adjusted by varying a plasma current which is applied to the plasma radiator. As a particular example, reference can be made to FIG. 4 which shows emission spectra of an incandescent lamp for varying temperatures.

Further, the exemplary spectrometer device 112 as schematically depicted in FIG. 1 comprises a photosensitive detector 120. As schematically illustrated in FIG. 1A, the photosensitive detector 120 has a single photosensitive region 122 which is designated for receiving the emitted optical radiation 114 after the emitted optical radiation 114 has been modified by an object 124 which is capable of absorbing a portion of the emitted optical radiation 114, wherein the object 124 may, typically, comprise a material under investigation by the spectrometer system 110. Herein, absorption of the of the emitted optical radiation 114 by the object 124 can be measured by recording a reflected portion of the emitted optical radiation 114 from the object 124 or by recording a transmitted portion of the emitted optical radiation 114 through the object 124. Most commonly, for liquids and gases the transmitted portion of the emitted optical radiation 114 may be measured, while the reflected portion of the emitted optical radiation 114 may be employed for solids.

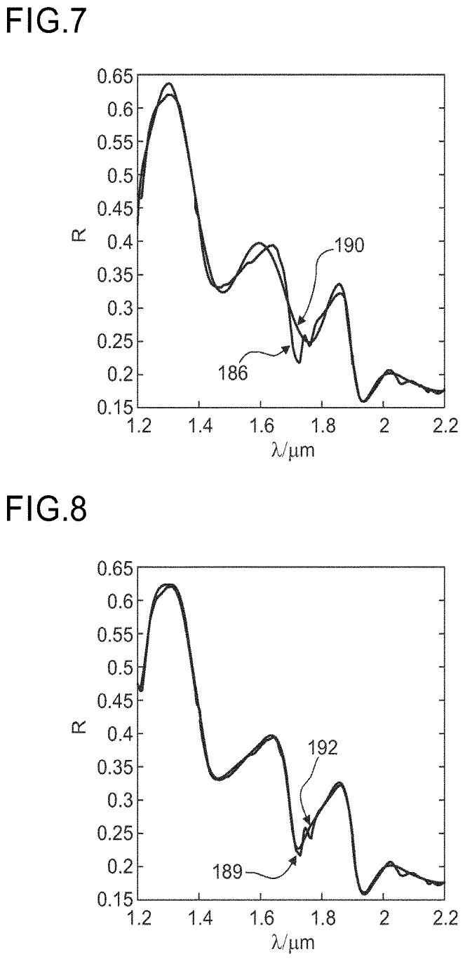

However, the photosensitive detector 120 may comprise more than one photosensitive regions 122, in particular two, three, four, five, six, seven, or eight photosensitive regions 122, in particular two photosensitive regions 122, 122′ as schematically illustrated in FIG. 1B, or four photosensitive regions 122, 122′, 122″, 122″ as schematically illustrated in FIG. 1C. Alternatively or in addition, the spectrometer device 112 may comprise more than one photosensitive detector 120 (not depicted here), in particular two, three, four, five, six, seven, or eight photosensitive detectors 120. As described below in more detail, the results presented in FIG. 6 have been acquired by using a single photosensitive region 122, while the results presented in FIGS. 7 and 8 have been acquired by using two individual photosensitive regions 122, 122′ or four individual photosensitive regions 122, 122′, 122″, 122″, respectively. By comparing the results as illustrated in FIGS. 6, 7 and 8 below, it is evident that, in this fashion, the resolution of the absorption spectrum can be improved. In general, the number of the photosensitive detectors 120 and/or of the photosensitive regions 122 can be increased until the desired resolution is reached, however, at cost of increasing complexity of and expenses for the spectrometer device 112.

In a particular embodiment in which two or more photosensitive detectors 120 or two or more photosensitive regions 122, 122′, 122″, 122″ may be used, different optical pass filters 125, 125′, 125″, 125″ which may, specifically, be selected from an optical short pass filer, an optical long pass filter and/or an optical band pass filter, may be placed in front each photosensitive detector 120, preferably in a fashion that each photosensitive detector 120 and/or each photosensitive region 122, 122′, 122″, 122″ may be equipped with a different optical pass filter 125, 125′, 125″, 125″ in a fashion as described above or below in more detail.

In the particular embodiment as schematically illustrated in FIG. 1, the spectrometer device 112 may comprise a housing 126, wherein the housing 126 may be configured such that the reflected portion of the emitted optical radiation 114 from the object 124 can be recorded. However, further embodiments of the housing 126 may also be feasible, in particular, an embodiment in which the housing 126 may comprise further parts, in particular the evaluation unit comprised by the spectrometer system 110 as described below in more detail.

Depending on an illumination of the photosensitive region 122 and on the temperature of the photosensitive detector 120, at least one detector signal 128 is generated by the photosensitive detector 120. The photosensitive region 122 may, preferably, be or comprise a single, uniform photosensitive area which is configured for receiving the emitted optical radiation 114 which impinges on the photosensitive area. The at least one detector signal 128 may be an analogue and/or a digital signal. In particular, the photosensitive detector 120 may be or comprise an active sensor which is adapted to amplify at least one detector signal 128 prior to providing it, for example, to an external evaluation unit. For this purpose, the photosensitive detector 120 may comprise one or more signal processing devices, in particular one or more filters and/or analogue-digital-converters for processing and/or preprocessing the electronic signals.

The photosensitive detector 120 can be selected from any known optical sensor, in particular from an inorganic camera element, preferably from an inorganic camera chip, more preferred from a CCD chip or a CMOS chip, which are, commonly, used in various cameras nowadays. As an alternative, the photosensitive detector 120, specifically the at least one photosensitive region 122, may comprise a photoconductive material, in particular an inorganic photoconductive material, especially selected from lead sulfide (PbS), lead selenide (PbSe), germanium (Ge), indium gallium arsenide (InGaAs, including but not limited to ext. InGaAs), indium antimonide (InSb), or mercury cadmium telluride (HgCdTe or MCT). As generally used, the term “ext. InGaAs” refers to a particular type of InGaAs which exhibits a spectral response up to 2.6 μm. As a further alternative, the photosensitive detector 120 may be or comprise a pyroelectric detector element, a bolometric detector element, or a thermopile detector element. As a further alternative, the at least one photosensitive detector may be or comprise a FIP sensor element as described above in more detail.

Further, the exemplary spectrometer device 112 as schematically depicted in FIG. 1 comprises a control circuit 130 which is configured for adjusting the temperature of the radiation emitting element 116 by applying at least one control signal 132 to the radiation emitting element 116. By using the control circuit 130, the temperature of the radiation emitting element 116 can, successively, be adjusted. In this fashion, an alteration of the spectral response of the radiation emitting element 116 can be obtained, which can be used for scanning a particular wavelength region of the spectrum of the object 124 as described above and below in more detail.

Alternatively or in addition, the control circuit 130 as illustrated in FIG. 1 can be configured for adjusting the temperature of the photosensitive detector 120 by providing a further control signal denoted by the dashed arrow carrying the reference sign “134” to the photosensitive detector 120. In a preferred embodiment, the temperature of the photosensitive detector 120 can be maintained constant by using the further control signal 134, which may be advantageous for increasing the signal-to-noise ratio of the at least one detector signal 128. In an alternative embodiment, the further control signal 134 can be used for adjusting the temperature of the photosensitive detector 120, which results in an alteration of the spectral response of the photosensitive detector 120. Concurrently, the temperature of the radiation emitting element 116 may, preferably, be maintained constant. As a result, this alternative embodiment allows scanning a particular wavelength region by controlling the temperature of the photosensitive detector 120.

The control circuit 130 may comprise one or more of a current source, a voltage source, a power source, or a pulse source which are designated for generating a current, a voltage, or an adjustable dissipated power, respectively, which are applied to the radiation emitting element 116, and/or to the photosensitive detector 120. In addition, the control circuit 130 may further comprise at least one of a current amplifier, a current delimiter, a voltage amplifier, or a voltage delimiter. Other or further parts are possible.

Further, the exemplary spectrometer device 112 as schematically depicted in FIG. 1 comprises a readout circuit 136 which is configured for measuring the at least one detector signal 128 as generated by the photosensitive detector 120 by recording at least one property related to the at least one detector signal 128, in particular at least one of an intensity, a current, a voltage, a resistance, a heat, a frequency, an electrical power, or a polarization of the at least one detector signal 128, or a time at which the at least one detector signal 128 is recorded. However, a recording of further properties, whether associated with the at least one detector signal 128 or not, may also be feasible.

As further schematically depicted in FIG. 1, apart from the spectrometer device 112 according to the present invention, the spectrometer system 110 further comprises an evaluation unit 138 which is designated for determining information that is related to a spectrum of the object 124. For this purpose, the evaluation unit 138 is configured for receiving the at least one detector signal 128, which is provided to the evaluation unit 138 in this exemplary embodiment by the readout circuit 136, which measures the at least one detector signal 128, via an interface 140 in a wire-bound or a wireless fashion. Generally, the evaluation unit 138 may be part of a data processing device 142 and/or may comprise one or more data processing devices 142. The evaluation unit 138 may be fully or partially embodied as a separate device 144 as schematically depicted in FIG. 1 and/or may fully or partially be integrated into the housing 126 which further comprises the spectrometer device 112 (not depicted here). The evaluation unit 138 may further comprise one or more additional components, in particular one or more electronic hardware components and/or one or more software components, in particular one or more measurement units and/or one or more evaluation units and/or one or more controlling units.

In a preferred embodiment, the evaluation unit 138 can also be designed to, completely or partially, control or drive the spectrometer device 112 or a part thereof. In particular, the evaluation unit 138 may be configured for controlling at least one of the radiation emitting element 116, the photosensitive detector 120, the control circuit 130, or the readout circuit 136. For this purpose, a keypad 146 can be used for receiving respective commands to be provided by a user of the spectrometer system 110. In particular, the evaluation unit can be designated to carry out at least one measurement cycle in which a plurality of detector signals 128 are picked up, especially, the detector signals 128 for successively adjusted temperatures of the radiation emitting element 116 and/or of the photosensitive detector 120 by driving the at least one control circuit 130 as schematically depicted in FIG. 1 by the dashed arrow which carries the reference sign “148”. Herein, acquiring the detector signals 128 can be performed sequentially, in particular, by using a temporal scan.

The information which is determined by the evaluation unit 138 can be provided to one or more further apparatus or users in an electronic, visual and/or acoustic fashion. By way of example, the information can be displayed using a monitor 150. Further, the information may be stored in a data storage device 152, wherein, as illustrated in FIG. 1, the data storage device 152 may be comprised by the evaluation unit 138. As an alternative, the data storage device 152 may be a separate storage device, wherein the information to the separate storage device may be transmitted via a further interface (not depicted here), in particular a wireless interface and/or a wire-bound interface.

As an alternative, at least one, preferably all, of the evaluation unit 138, the processing device 142, the keypad 146, the monitor 150 and the data storage device 152 may be integrated into an electronic communication device, specifically selected from a smartphone or a tablet.

FIG. 2 illustrates, in a highly schematic fashion, a view of an exemplary embodiment of a method 160 for measuring the optical radiation 114 according to the present invention.

In an emitting step 162 according to step a), the desired optical radiation 114 is emitted by using the radiation emitting element 116, wherein a spectrum of the emitted optical radiation 114 is dependent on a temperature of the radiation emitting element.

In a generating step 164 according to step b), the at least one detector signal 128 is generated by using the one or more photosensitive detectors 120, wherein the at least one photosensitive detector 120 has a photosensitive region 122 which is designated for receiving the emitted optical radiation 114. Herein, the at least one detector signal 128 is dependent on an illumination of the photosensitive region 122 and on the temperature of the one or more photosensitive detectors 120.

In an adjusting step 166 according to step c), the temperature of the radiation emitting element 116 and/or of the one or more photosensitive detectors 120 is adjusted by providing the at least one control signal 132, 134 to the radiation emitting element 116 and/or the one or more photosensitive detectors 120. Preferably, the at least one control signal 132, 134 may be provided by the control circuit 130.

In a measuring step 168 according to step d), the at least one detector signal 128 which is generated by one or more photosensitive detectors 120 is measured, in particular, by the readout circuit 136 and, preferably, transmitted to the evaluation unit 138 via the interface 140.

In an optional evaluating step 170, desired spectral information 172 related to a spectrum of the object 124 can be determined by using the evaluation unit 138, in particular based on the at least one detector signal 128.

For further details concerning the method 160 for measuring the optical radiation 114, reference may be made to the description of the spectrometer device 112 as provided above.

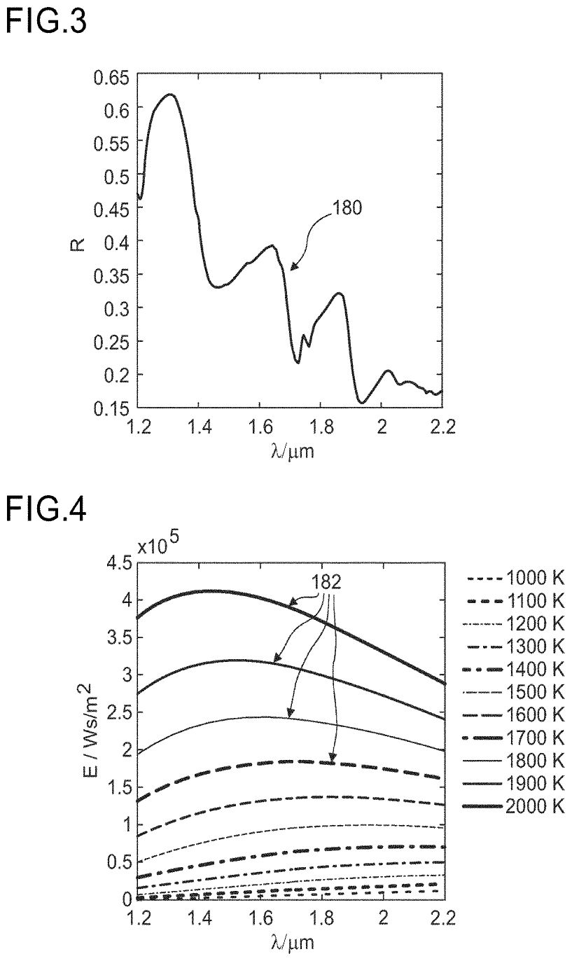

FIG. 3 illustrates an exemplary reflection spectrum 180 of canola seeds as already known from prior art. Canola seeds comprise seeds of the genus Brassica, in particular Brassica napus, Brassica rapa or Brassica juncea, from which the oil shall contain less than 2% erucic acid in its fatty acid profile and the solid component shall contain less than 30 micromoles of any one or any mixture of 3-butenyl glucosinolate, 4-pentenyl glucosinolate, 2-hydroxy-3 butenyl glucosinolate, and 2-hydroxy-4-pentenyl glucosinolate per gram of air-dry, oil-free solid, see https://www.canolacouncil.org/oil-and-meal/what-is-canola/#OfficialDefinition (retrieved Jul. 21, 2020). In the diagram according to FIG. 3, a reflection R is depicted as a fraction of reflected optical radiation versus a wavelength A of the optical radiation in μm. The prior art reflection spectrum of the canola seeds has been measured by using a Michelson interferometer for the wavelengths of 1.2 μm to 2.2 μm.

FIG. 4 illustrates black body emission spectra 182 of an incandescent lamp for varying temperatures as known from prior art. The black body emission spectra 182 depicted there as emission E in 10⁵·W·s/m² versus the wavelength A of the optical radiation in μm have been determined by taking into account black the body radiation of the incandescent lamp for temperatures of 1000K to 2000K applying steps of 100K.

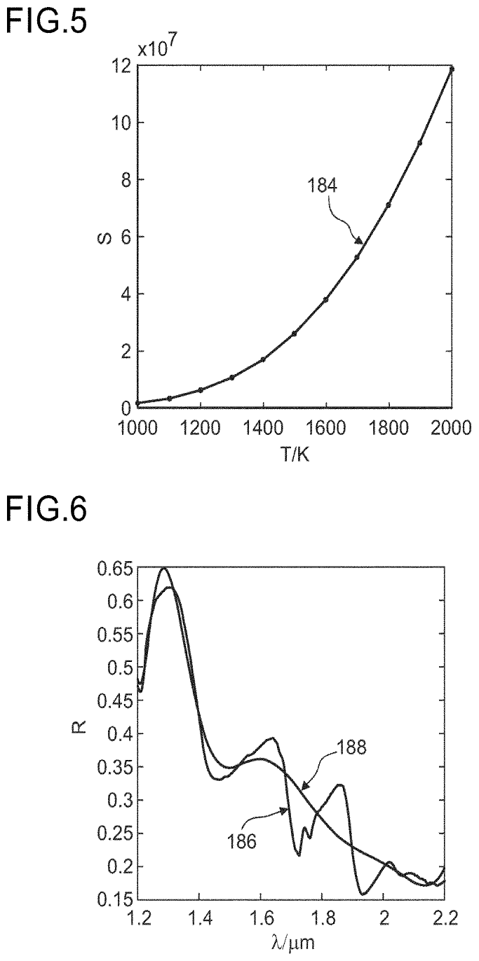

FIG. 5 illustrates a course 184 of detectors signals S in arbitrary units, wherein the detectors signals S have been generated by a photosensitive detector 120 for varying temperatures of the incandescent lamp. The course 184 of the detectors signals S versus temperature T in K has been determined by a convolution of the reflection spectrum 180 of FIG. 3, of the black body emission spectrum 182 of FIG. 4, and of a spectral responsivity of a PbS detector to be used as the photosensitive detector 120.

FIGS. 6, 7 and 8 each illustrates a comparison of a calculated reflection spectrum 186 with a measured reflection spectrum 188, 190, 192 of canola seeds. Herein, the calculated reflection spectrum 186 has been determined by using Equation (1) as presented above. Herein
the measured reflection spectrum 188 in FIG. 6 was obtained by using a single PbS detector as illustrated in FIG. 1A;
the measured reflection spectrum 190 in FIG. 7 was obtained by using two individual photosensitive regions 122, 122′ as illustrated in FIG. 1B each comprising PbS as the photosensitive material, wherein a first bandpass filter between 1.2 μm and 1.9 μm was placed in front of a first PbS detector and a second bandpass filter between 1.9 μm and 2.2 μm was placed in front of a second PbS detector; and
the measured reflection spectrum 192 in FIG. 8 was obtained by using four individual photosensitive regions 122, 122′, 122″, 122′″ as illustrated in FIG. 1C each comprising PbS as the photosensitive material, wherein a first bandpass filter between 1.2 μm and 1.4 μm was placed in front of a first PbS detector, a second bandpass filter between 1.4 μm and 1.7 μm was placed in front of a second PbS detector, a third bandpass filter between 1.7 μm and 1.9 μm was placed in front of a third PbS detector, and a fourth bandpass filter between 1.9 μm and 2.2 μm was placed in front of a fourth PbS detector.

A view of FIG. 6 demonstrated that the spectral resolution is strongly smoothed, since the emission spectrum of the incandescent lamp is very broad compared to any scanning spectrometer, wherein the transmission bandwidth of the scanning element is much smaller, e.g. a single detector Fabry-Perot Interferometer has a bandwidth less about some nanometers.

However, by increasing the number of detectors with adequate bandpass filters, a combination of a dispersive spectrometer and a scanning spectrometer approach can be achieved. In the measured reflection spectrum 190 of FIG. 7, which is recorded by using two individual photosensitive regions 122, 122′, an increase in the spectral resolution can be observed.

A further increase of number of individual photosensitive regions 122, 122′, 122″, 122′″ from two to four leads to a much better resolution as shown in FIG. 8. Compared to an optimized dispersive spectrometer, which comprises detector arrays having 128, 256, 1024, 2096 or more pixels, the number of four individual photosensitive regions 122, 122′, 122″, 122′″ as used for obtaining the measured reflection spectrum 192 of FIG. 8 appears rather poor. Thus, by combining the two approaches, scanning spectrometry and dispersive spectrometry, a reasonable spectral resolution can be achieved without requiring expensive arrays or scanning elements and without requiring a fast modulated light source.

### LIST OF REFERENCE NUMBERS

110 spectrometer system
112 spectrometer device
114 (emitted) optical radiation
116 radiation emitting element
118 thermal radiator
120 photosensitive detector
122, 122′, . . . photosensitive region
124 object
125, 125′, . . . optical band pass filter
126 housing
128 detector signal
130 control circuit
132 control signal
134 control signal
136 readout circuit
138 evaluation unit
140 interface
142 processing device
144 separate device
146 keypad
148 arrow
150 monitor
152 data storage device
160 for measuring optical radiation
162 emitting step
164 generating step
166 adjusting step
168 measuring step
170 evaluating step
172 spectral information
180 reflection spectrum
182 black body emission spectrum
184 course
186 calculated reflection spectrum
188 measured reflection spectrum
190 measured reflection spectrum
192 measured reflection spectrum

1. A spectrometer device for measuring optical radiation, comprising:
at least one radiation emitting element, wherein the at least one radiation emitting element is designed for emitting optical radiation, wherein a spectrum of the emitted optical radiation is dependent on a temperature of the radiation emitting element;
at least one photosensitive detector, wherein the at least one photosensitive detector has at least one photosensitive region designated for receiving the emitted optical radiation, wherein at least one detector signal generated by the at least one photosensitive detector is dependent on an illumination of the at least one photosensitive region and on the temperature of the at least one photosensitive detector;
at least one control circuit, wherein the at least one control circuit is configured for
determining the spectrum of the optical radiation emitted by the at least one radiation emitting element by using Planck's law with a known temperature, and
adjusting the temperature of at least one of the at least one radiation emitting element or the at least one photosensitive detector by applying at least one control signal to the at least one of the at least one radiation emitting element or to the at least one photosensitive detector; and
at least one readout circuit, wherein the at least one readout circuit is configured for measuring the at least one detector signal as generated by the at least one photosensitive detector.

2. The spectrometer device according to claim 1, wherein the at least one control circuit is configured for adjusting the temperature of the at least one radiation emitting element or of the at least one photosensitive detector by providing the at least one control signal to the at least one radiation emitting element or to the at least one photosensitive detector.

3. The spectrometer device according to claim 1, wherein the at least one radiation emitting element comprises at least one thermal radiator.

4. The spectrometer device according to claim 3, wherein a peak wavelength of the emitted optical radiation is a function of temperature according to Wien's displacement law.

5. The spectrometer device according to claim 1, wherein the temperature of the at least one radiation emitting element is a function of the at least one control signal.

6. The spectrometer device according to claim 1, wherein the least one photosensitive detector comprises at least one photoconductive material.

7. The spectrometer device according to the claim 6, wherein the at least one photoconductive material is selected from the group consisting of PbS, PbSe, Ge, InGaAs, InSb, and HgCdTe.

8. The spectrometer device according to claim 1, wherein at least one optical pass filter is placed in a radiation path in front of the at least one photosensitive region.

9. The spectrometer device according to claim 8, comprising two, three, four, five, six, seven, or eight photosensitive detectors and/or photosensitive regions.

10. A spectrometer system, comprising
at least one spectrometer device for measuring optical radiation according to claim 1; and
an evaluation unit designated for determining information related to a spectrum of an object by evaluating at least one detector signal as provided by the spectrometer device.

11. A method for measuring optical radiation, the method comprising the following steps:
a) emitting optical radiation using at least one radiation emitting element, wherein a spectrum of the emitted optical radiation is dependent on a temperature of the radiation emitting element;
b) generating at least one detector signal using at least one photosensitive detector, wherein the at least one photosensitive detector has at least one photosensitive region designated for receiving the emitted optical radiation, wherein the at least one detector signal is dependent on an illumination of the at least one photosensitive region and on the temperature of the at least one photosensitive detector;
c) determining the spectrum of the optical radiation emitted by the at least one radiation emitting element by using Planck's law with a known temperature, and adjusting the temperature of at least one of the at least one radiation emitting element or the at least one photosensitive detector by applying at least one control signal to the at least one of the at least one radiation emitting element or to the at least one photosensitive detector; and
d) measuring the at least one detector signal as generated by the at least one photosensitive detector.

12. The method according to claim 11, wherein step c) comprises adjusting the temperature of the at least one radiation emitting element or of the at least one photosensitive detector by providing the at least one control signal to the at least one radiation emitting element or to the at least one photosensitive detector.

13. The method according to claim 11, wherein a peak wavelength of the emitted optical radiation is shifted by adjusting the temperature of the at least one radiation emitting element.

14. The method according to claim 13, wherein the peak wavelength as a function of the temperature of the at least one radiation emitting element is known analytically or is determined by applying a calibration process.

15. The method according to claim 11, wherein the emitted optical radiation reaches the at least one photosensitive detector by at least one of being reflected by an object or being transmitted through the object.
